(19) United States
(12) Patent Application Publication
(10) Pub. No.: US 2009/0134232 A1
(43) Pub. Date: May 28, 2009

(54) SYSTEM FOR PROVIDING HUMIDIFICATION AND DEHUMIDIFICATION TO INDOOR ENVIRONMENT

(76) Inventor: Scott H. Larsen, Newburgh, IN (US)

Correspondence Address: C RICHARD MARTIN;MARTIN & MARTIN, ATTORNEYS AT LAW, PC, PO BOX 29, BOONVILLE, IN, 47601, US

(21) Appl. No.: 12/274,946

(22) Filed: Nov. 20, 2008

Related U.S. Application Data
(60) Provisional application No. 60/989,610, filed on Nov. 21, 2007.

(51) Int. Cl. F24F 3/14; F25D 21/14; F25D 17/06; G05B 15/00

(52) U.S. Cl. 236/44 C; 62/288; 62/426; 700/276

(57) ABSTRACT

An apparatus to improve human comfort by selectively humidifying or dehumidifying the air within a building to comfortably allow a higher temperature during summer conditions, and for selectively humidifying the air when desired at certain times of the year is provided. The apparatus includes a humidification/dehumidification unit that can provide either humidified or dehumidified air on demand; a sophisticated thermostat that includes a humidity control system, to monitor and maintain both winter and summer humidity control; and a blower fan control system to quietly distribute conditioned air throughout the home using the existing blower fan and ductwork.

### FIELD OF THE INVENTION

The present invention relates generally to the conditioning of air within a building. More particularly, the present invention relates to a method and apparatus for extracting air from a building for the purpose of dehumidifying the air, combined with the capacity to alternatively and selectively humidify the air.

### BACKGROUND OF THE INVENTION

For many years, several manufacturers have offered products of various designs to provide additional moisture (humidity) throughout the interior of a building or structure. These products have become quite refined, and are easy to install and maintain. They typically work on the basis of opening a valve and allowing water to trickle over a medium that allows air to flow through and evaporate the water. Alternatively, they may heat water to the point of evaporation, or use ultrasonics or other methods to introduce water (humidity) into the air. They typically only operate when the furnace blower fan is operating. Significant humidity gains can be achieved, and there is a synergy in that the natural humidity is typically lowest when the outside temperature is the lowest; therefore more frequent heat cycling offers greater opportunities to introduce humidity into the airflow.

The reverse situation—dehumidification, or removal of water from the air in the home—has proven to be more difficult. Portable dehumidifiers are sold in large numbers, but they serve only limited areas in the home such as a basement, a bathroom or the laundry area. Their effect on an entire home is usually minimal. They are often viewed as an annoyance in that they are unattractive, intrusive, noisy devices that require regular attention (emptying water catch pans) and possibly worst of all: the process of condensing water involves the generation of significant amounts of heat, which makes the room in which they operate uncomfortably warm.

Several manufacturers have developed whole-house dehumidifiers, which can be very effective. They are not widely used because, 1) they are costly due to their time-consuming installation requirements and the fact that they are built in such limited numbers, 2) they are often unattractive and intrusive wherever installed, such as a garage or basement, and 3) they are little-known by the consumer, since most HVAC companies don't choose to offer them. They aren't promoted because they are a tough sale for the reasons listed above, particularly the expense, and they are a time-consuming and often difficult installation for the amount of profit potential they offer for the installer. They can take longer to install than an entire replacement furnace and air conditioning system, but customers are seldom willing to pay a corresponding price. On the other hand, they do offer an effective, whole-house solution to humidity problems, and since they are designed and typically installed to introduce the dehumidified air into the HVAC ducts for wide distribution, the impact of the heat they generate is not noticeable to the occupants.

As shown in FIGS. 1 & 2, Existing high humidity solutions involve a stand-alone system for getting the air into the duct system for wide distribution. The point(s) of air collection have traditionally needed to be far-removed from the point(s) of air delivery, or the airflow will ‘short-circuit’ the intent to provide whole-home dehumidification. Return air will always take the easiest (and therefore shortest) route, so the answer has been to widely separate the collection and delivery points. The distribution usually requires the use of powered or passive dampers, long runs of flexible or rigid ducting through the attic, garage and/or crawl space, adding additional registers to the home, and so on.

Excessive humidity is introduced into a home from many sources. Federal government recommendations call for a total air exchange with the outside air 3-4 or more times each day, so hot, humid air is permitted and often encouraged to infiltrate into the home. Other typical sources are: damp crawl spaces, basements, or slab foundations; respiration of the occupants; bathing; cooking; and numerous other typical activities and conditions. Excessive humidity is a big problem, especially in the south, where high humidity conditions are noted during most or even all of the months of the year.

Higher-efficiency air-conditioning equipment is a little-known contributor to the humidity problem. Humidity removal has always been a side benefit from the process of cooling the air. Government regulations for greater cooling energy efficiencies (a mandated 30% efficiency improvement from 10 SEER to 13 SEER went into effect in 2006, for example) have forced the manufacturers to provide substantial cooling gains for the same electrical input. Since condensing water represents a significant share of the energy used by air conditioning equipment, less condensation means a higher rated efficiency. To achieve the higher mandated efficiencies, among other changes the manufacturers have designed the cooling coils to run at warmer temperatures. Larger, warmer coils translate into higher air temperatures at the point where cooling and condensation takes place, and therefore less condensation . . . but increased cooling for the energy dollar. The growing emphasis on energy efficiency will only add to the need for cost-effective, dedicated dehumidification in the home.

As an example, a home at 78 degrees and 45% humidity would be considered comfortable by most people. The same home at 78 degrees and 60% humidity, while fairly typical in many homes, would not be considered very comfortable. Suppose the occupants change the thermostat setting to lower the temperature to 70 degrees. If the air conditioning isn't effectively removing humidity while maintaining the 70 degrees (at night, a cloudy day, etc.) then all else remaining the same, the relative humidity would skyrocket to 79 percent. This creates conditions that support condensation inside walls and in crawl spaces, which leads directly to mold and rot.

### SUMMARY OF THE INVENTION

The present invention provides a unique, inexpensive, compact, all-purpose total humidity control device that will serve the entire interior of a building or residence. While there are devices that can add humidity to a dry home in winter, and there are devices that can remove humidity from an excessively damp home in summer, there is no single, essentially self-contained device that, when installed, can automatically control all humidity conditions. The present invention accomplishes humidification and dehumidification tasks . . . once installed and programmed . . . without further intervention, indefinitely, with only minor recommended maintenance associated with normal furnace or heat pump seasonal cleaning and filter changing.

According to one aspect of the present invention there is provided an apparatus for selectively humidifying or dehumidifying the air within a building including a humidification/dehumidification unit that can provide either humidified or dehumidified air on demand; a sophisticated thermostat that includes a humidity control system, to monitor and maintain both winter and summer humidity control; and a blower fan control system to quietly distribute conditioned air throughout the home using the existing blower fan and ductwork.

According to a further aspect of the present invention, there is provided an apparatus for controlling the humidity of air circulated through a plenum of an HVAC system within a building including a housing having a first opening for introducing air from the plenum and a second opening for returning air to the plenum; a humidification unit positioned within the housing proximal to one of the first or second openings; a dehumidification unit positioned within the housing proximal to the other one of the first or second openings; a fan positioned within the housing to move air from the plenum through the first opening through the housing and returning the air to the plenum through the second opening; and a control system electrically connected to the humidification unit, dehumidification unit, and fan for monitoring and maintaining humidity control. The humidification unit is preferably positioned proximal to the second opening and the dehumidification unit is positioned proximal to the first opening. The humidification unit includes a humidification pad positioned between the fan and the second opening; and a water supply line having an outlet positioned above the humidification pad. The humidification unit may further include an overflow collection pan positioned below the humidification pad; and a drain hose having a first end connected to an opening in the overflow collection pan. The dehumidification unit includes condensing coils positioned proximal to the first opening; evaporator coils positioned adjacent the condensing coils between the condensing coils and the first opening; and a compressor for circulating coolant through the condensing coils and evaporator coils. The dehumidification unit may further include a filter positioned between the evaporator coil and the first opening; a collection pan located below the condensing coils and the evaporator coils; and a drain hose having a first end connected to an opening in the collection pan. The control system includes a programmable thermostat located remotely from the housing, and an interface module positioned proximate to the housing and electrically connected to the programmable thermostat. The interface module may be electrically connected to the programmable thermostat by one or more wires. An electronic fan speed control device may also be electrically connected to the interface module and also electrically connected to a blower motor of the HVAC system for selectively controlling the speed of an HVAC blower fan when the HVAC system does not call for heating or cooling, but calls for humidification or dehumidification. Temperature sensors may be positioned on the plenum at the rear of an evaporator coil of the HVAC system. The sensors may be electrically connected to the interface module and provide data for determining the proper speed of the HVAC blower fan.

According to yet a further aspect of the present invention, there is provided an apparatus for controlling the humidity of air circulated through a plenum of an HVAC system within a building including a housing having a first opening for introducing air from the plenum and a second opening for returning air to the plenum; a dehumidification unit positioned within the housing proximal to the other one of the first or second openings; a fan positioned within the housing to move air from the plenum through the first opening through the housing and returning the air to the plenum through the second opening; and a control system electrically connected to the dehumidification unit, and fan for monitoring and maintaining humidity control. The dehumidification unit includes condensing coils positioned proximal to the first opening; evaporator coils positioned adjacent the condensing coils between the condensing coils and the first opening; and a compressor for circulating coolant through the condensing coils and evaporator coils. The dehumidification unit may further include a filter positioned between the evaporator coil and the first opening; a collection pan located below the condensing coils and the evaporator coils; and a drain hose having a first end connected to an opening in the collection pan.

Accordingly, it is an object of the present invention to provide exchange of air in an enclosed space of a building while selectively and alternately providing either dehumidification while the enclosed space is being cooled or humidification while the enclosed space is being heated.

It is a further object of the present invention to provide humidification/dehumidification to the enclosed space of a building independent of the cooling or heating thereof.

It is a further object of the present invention to provide a cost effective system that can be quickly and easily integrated into an existing HVAC system for selectively humidifying or dehumidifying the air.

These and other objects, features and advantages of the present invention will become apparent with reference to the text and the drawings of this application.

### BRIEF DESCRIPTION OF THE DRAWINGS

FIG. 1 is a diagrammatic representation of a prior art whole-house dehumidification system.

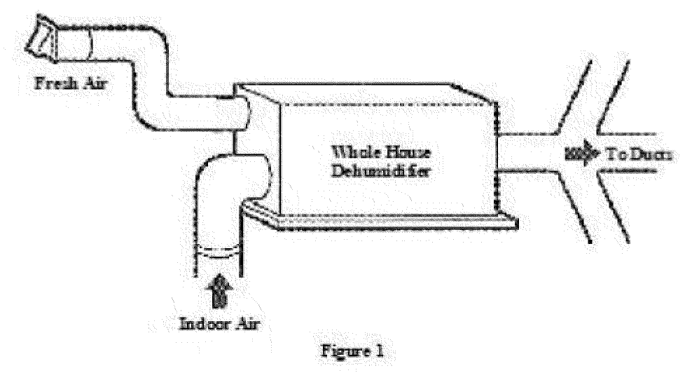

FIG. 2 is a diagrammatic representation of another prior art whole-house dehumidification system.

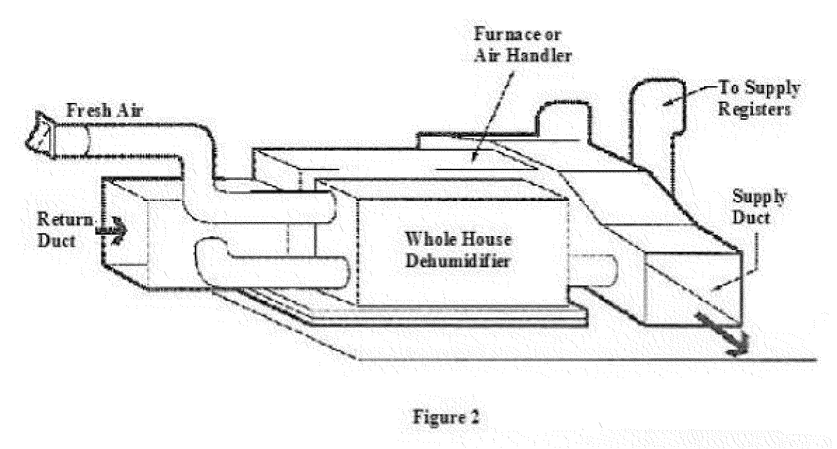

FIG. 3 is a top plan view of a combined humidification/dehumidification control unit according to one preferred embodiment of the present invention.

FIG. 4 is a side view in elevation of a combined humidification/dehumidification unit according to one preferred embodiment of the present invention.

FIG. 5 is a front view in elevation of a combined humidification/dehumidification control unit according to one preferred embodiment of the present invention.

FIG. 6 is a schematic diagram of the combined system for providing selective humidification or dehumidification to a building according to one preferred embodiment of the present invention.

### DETAILED DESCRIPTION

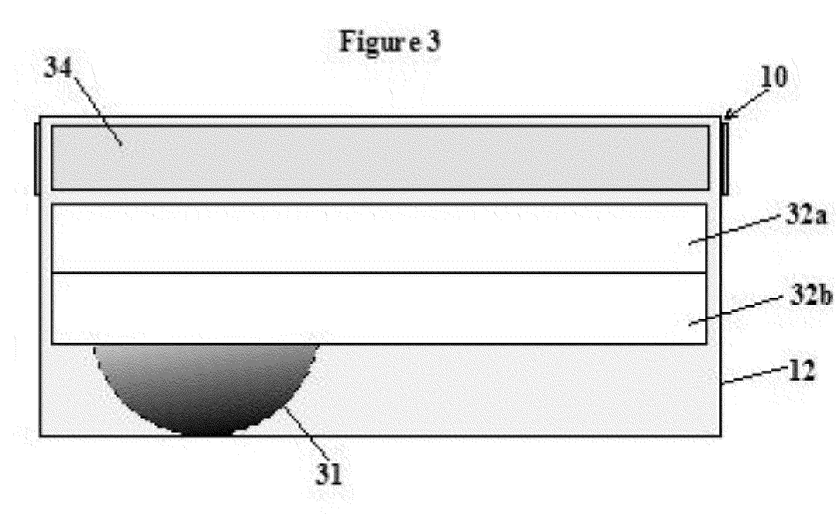

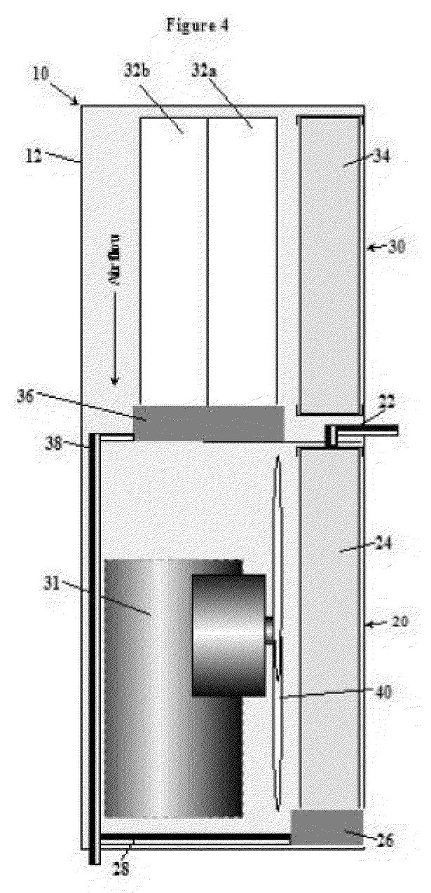

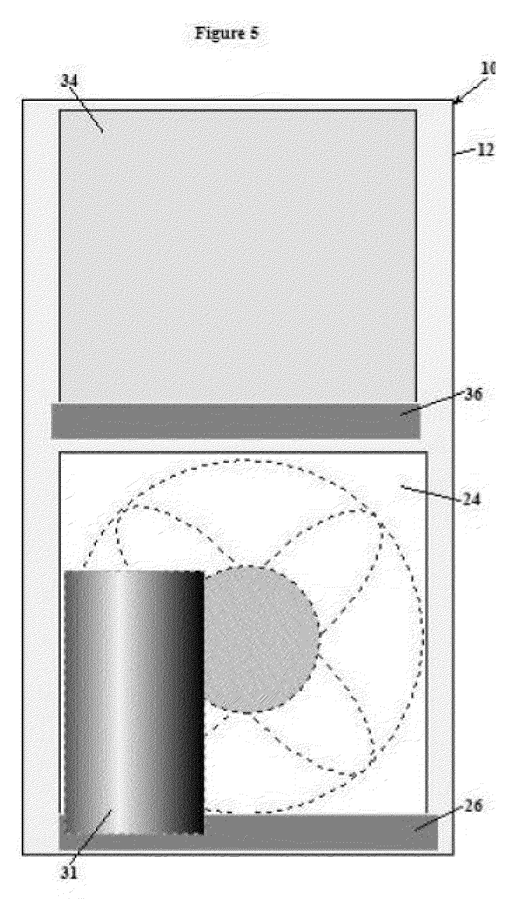

Referring to FIGS. 3-5, there is illustrated a combined humidification/dehumidification unit 10 according to one aspect of the present invention. The unit 10 includes an outer housing 12 that may be made of any suitable material such as sheet metal or, alternatively a molded plastic enclosure which, with more compact components, may be used to reduce the weight and size of the unit in addition to making the unit more aesthetically pleasing.

The internal components of the combined humidification and dehumidification unit 10 comprise a humidification unit 20 to add water to the air that is presented to the unit when desired and a dehumidification unit 30 to remove water from the air that is presented to the unit when desired. A self-contained fan 40 moves the air through the unit 10, taking the air directly from the plenum and returning it to the plenum after humidification/dehumidification has occurred.

The humidification unit 20 according to the embodiment shown in FIGS. 3-5 includes a water supply line 22, humidification pad 24, overflow collection pan 26 and drain hose 28. In operation, water is supplied to the humidification pad 24 via water supply line 22. The fan 40 then forces air through the moistened humidification pad 24, thereby adding moisture to the air, and back into the plenum. Excess water from the humidification pad 24 falls into the collection pan 26 and is removed from the unit via drain hose 28, which may be connected to the building's drain system. Alternatively, a steam generator (not shown), ultrasonic device (not shown) or other method of evaporation (not shown) could be utilized to add humidity when needed.

The dehumidification unit 30 according to the embodiment shown in FIGS. 3-5 includes a compressor 31, cooling (evaporator) coils 32a and reheating (condensing) coils 32b, filter 34, overflow collection pan 36 and drain hose 38. In operation, air is drawn by the fan 40 into the unit 10 through filter 34. The air then passes through coils 32 which remove humidity from the air. The water removed from the air drips from the cooling coil into collection pan 36 and is directed to the building's drain system via drain hose 38.

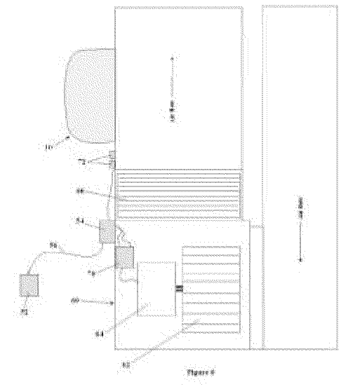

A control system 50, as shown in FIG. 6, such as a Honeywell VisionPRO IAQ product, is provided to control the unit 10, and includes a programmable thermostat 52 that can be located remotely from the unit 10, and an interface module 54 that typically mounts on or in the unit 10 and adjacent to the furnace/air handler unit 60. The programmable thermostat 52 is electrically connected to the interface module 54 by three wire leads 56. Wireless connection between the programmable thermostat and interface module is also contemplated. This control system 50 can control multi-stage furnaces, dual-fuel equipment, heat pumps, etc. For the purposes of this humidity solution, the control system 50 can monitor humidity conditions in the home at the thermostat location 52 which can detect the relative humidity of the ambient air in the building. The programmable thermostat 52 can be set to a desired relative humidity for both humidification and dehumidification conditions and thereby acts as a trigger to either humidification or dehumidification conditioning when conditions are above or below the set points. An ideal range would be relative humidity no less than 35% and no higher than 45%, however, these ideal ranges will vary in different climate zones and to address the occupants' preferences. For the purposes of the present invention, the humidification and dehumidification control system, along with its three-wire communications between the thermostat and interface module, makes it suitable for retrofit or new home installations.

The control system 50 monitors and controls the speed of the furnace or heat pump blower fan 62, automatically. Dehumidification can occur simultaneously with air conditioning, but when air-conditioning (cooling) is not taking place, the dehumidification process can be accomplished quietly, comfortably and without introducing noticeable draftiness into the home. The previously described problems with short-circuiting the airflow are addressed with this control system. By providing airflow through the plenum, dehumidification of the entire building can be accomplished by the unit 10, without engaging the furnace or air conditioner heating or cooling processes. Heating and cooling systems that use a variable speed blower will require an alternative method of turning on the blower at a slow speed, which is in fact easier and less expensive to accomplish than what is outlined here for more typical HVAC systems.

A key aspect of the present invention is to provide a gentle, slow and quiet airflow throughout the building. Control of the blower fan 62, independent of heating or cooling, is important to the dehumidification aspect of this device. To accomplish this, a simple electronic fan speed control device 70 is electrically connected to the blower fan motor 64. This control device 70 will effectively control blower fan speed based upon moment-to-moment need, as determined by sensors 72 that monitor the air temperature as it comes off the furnace/AC evaporator coil 66. The blower fan control device 70 will provide a substantial reduction in fan energy use, as reducing fan speeds by half reduces power use by about 80%. The speed of the blower fan 62 is constantly adjusted to the needs of the moment during both heating and cooling cycles. When neither heating nor cooling is called for but dehumidification is active, the control device defaults to an adjustable, very slow speed. This permits whole-home distribution of dehumidified air at any time, for as long as is needed. Side benefits are that this fan control speed will often make a heat pump's air feel warmer in the winter, and it will slow down the air passing through the cooling coil in the summer, which will make it run colder. This encourages more humidity removal. It will also enhance air filtration, as slower moving air leaves more of the smaller and more harmful contaminants in the filter media.

The fan speed control device 70 may be mounted in the furnace or air handler unit 60 adjacent to the fan motor 64, and a simple two-wire low-voltage connection from the interface module 54 of the control system 50 will engage the blower when needed. If the thermostat calls for either cooling or heating, this will have no effect on humidification control system 50, which will continue to operate independently until the humidity setting has been satisfied.

As previously noted, there are products available that address humidification. It would be feasible to build a product that only addresses dehumidification. A product that addresses both humidification and dehumidification costs little more to build and it offers the opportunity to address a “total humidity solution.”

The foregoing is provided for purposes of illustrating, explaining, and describing embodiments of the present invention. The specific components and order of the steps listed above, while preferred is not necessarily required. Further modifications and adaptation to these embodiments will be apparent to those skilled in the art and may be made without departing from the scope or spirit of the invention.

I claim:

1. An apparatus for controlling the humidity of air circulated through a plenum of an HVAC system within a building comprising:
a housing having a first opening for introducing air from the plenum and a second opening for returning air to the plenum;
a humidification unit positioned within the housing proximal to one of said first or second openings;
a dehumidification unit positioned within the housing proximal to the other one of said first or second openings;
a fan positioned within the housing to move air from the plenum through said first opening through the housing and returning the air to the plenum through said second opening; and
a control system electrically connected to said humidification unit, said dehumidification unit and said fan for monitoring and maintaining humidity control.

2. The apparatus of claim 1 wherein said humidification unit is positioned proximal to the second opening and said dehumidification unit is positioned proximal to said first opening.

3. The apparatus of claim 2 wherein the humidification unit comprises:
a humidification pad positioned between the fan and the second opening; and
a water supply line having an outlet positioned above said humidification pad.

4. The apparatus of claim 3 wherein the humidification unit further comprises:
an overflow collection pan positioned below said humidification pad; and
a drain hose having a first end connected to an opening in said overflow collection pan.

5. The apparatus of claim 2 wherein the dehumidification unit comprises:
condensing coils positioned proximal to the first opening;
evaporator coils positioned adjacent said condensing coils between the condensing coils and the first opening; and
a compressor for circulating coolant through said condensing coils and said evaporator coils.

6. The apparatus of claim 5, wherein the dehumidification unit further comprises:
a filter positioned between said evaporator coil and said first opening;
a collection pan located below said condensing coils and said evaporator coils; and
a drain hose having a first end connected to an opening in said collection pan.

7. The apparatus of claim 1, wherein the control system comprises:
a programmable thermostat located remotely from the housing;
an interface module positioned proximate to the housing and electrically connected to the programmable thermostat.

8. The apparatus of claim 7, wherein the interface module is electrically connected to the programmable thermostat by one or more wires.

9. The apparatus of claim 7, further comprising an electronic fan speed control device electrically connected to the interface module and also electrically connected to a blower motor of the HVAC system for selectively controlling the speed of an HVAC blower fan when the HVAC system does not call for heating or cooling, but calls for humidification or dehumidification.

10. The apparatus of claim 7, further comprising temperature sensors positioned on the plenum at the rear of an evaporator coil of the HVAC system, said sensors further being electrically connected to the interface module and providing data for determining the proper speed of the HVAC blower fan.

11. An apparatus for controlling the humidity of air circulated through a plenum of an HVAC system within a building comprising:
a housing having a first opening for introducing air from the plenum and a second opening for returning air to the plenum;
a dehumidification unit positioned within the housing;
a fan positioned within the housing to move air from the plenum through said first opening through the housing and returning the air to the plenum through said second opening; and
a control system electrically connected to said dehumidification unit and said fan for monitoring and maintaining humidity control.

12. The apparatus of claim 11 wherein the dehumidification unit comprises:
condensing coils positioned proximal to the first opening;
evaporator coils positioned adjacent said condensing coils between the condensing coils and the first opening; and
a compressor for circulating coolant through said condensing coils and said evaporator coils.

13. The apparatus of claim 12, wherein the dehumidification unit further comprises:
a filter positioned between said evaporator coil and said first opening;
a collection pan located below said condensing coils and said evaporator coils; and
a drain hose having a first end connected to an opening in said collection pan.
